(19) United States
(12) Patent Application Publication
(10) Pub. No.: US 2014/0297188 A1
(43) Pub. Date: Oct. 2, 2014

(54) TIME-FREQUENCY REPRESENTATIONS OF SEISMIC TRACES USING WIGNER-VILLE DISTRIBUTIONS

(71) Applicant: CGG SERVICES SA, Massy Cedex (FR)

(72) Inventors: Ibrahim ZOUKANERI, Villahermosa (MX); Milton J. PORSANI, Salvador (BR)

(73) Assignee: CGG SERVICES SA, Massy Cedex (FR)

(21) Appl. No.: 14/227,471

(22) Filed: Mar. 27, 2014

Related U.S. Application Data
(60) Provisional application No. 61/806,495, filed on Mar. 29, 2013.

(51) Int. Cl. G01V 1/30

(52) U.S. Cl. CPC G01V 1/30
USPC 702/14

(57) ABSTRACT

Presented are methods and systems for reducing or eliminating spurious error or cross-terms when using bilinear functions in a time-frequency analysis. A maximum entropy method is applied to a Wigner-Ville distribution of seismic traces to provide a robust and high resolution time-frequency representation of the seismic traces.

### RELATED APPLICATION

The present application is related to, and claims priority from U.S. Provisional Patent Application No. 61/806,495, filed Mar. 29, 2013, entitled “HIGH RESOLUTION TIME-FREQUENCY REPRESENTATION OF SEISMIC TRACES USING WIGNER-VILLE DISTRIBUTION AND MAXIMUM ENTROPY METHOD,” to Ibrahim ZOUKANERI et al., the disclosure of which is incorporated herein by reference.

### TECHNICAL FIELD

Embodiments of the subject matter disclosed herein generally relate to methods and systems for seismic data processing and, more particularly, to methods and devices which generate time-frequency representations of seismic traces.

### BACKGROUND

Seismic data acquisition and processing techniques are used to generate a profile (image) of a geophysical structure (subsurface) of the underlying strata. This profile does not necessarily provide an accurate location for oil and gas reservoirs, but it may suggest, to those trained in the field, the presence or absence of oil and/or gas reservoirs. However the generation of this profile requires a large amount of data processing to be performed on the raw data generated by a seismic survey. Thus, providing an improved image of the subsurface in a shorter period of time via processing of the survey data is an ongoing goal of research in this area.

As described by B. Boashash (hereinafter “BOASHASH”) in his 1992 article entitled “Estimating and Interpreting the Instantaneous frequency of a Signal—Part 1: Fundamentals,” published in the Proceedings of the IEEE, Vol. 80, No. 4, April 1992, pages 520-538, the disclosure of which is incorporated herein by reference, during recent years, time-frequency (TF) or time-scale representations have found significant application in non-stationary analysis of a wide range of signals including seismic signals. Further, the position of peaks in the time-frequency representation reveals the main components or structures of the signal making the representation useful for seismic data analysis and reservoir characterization as described by X. Wang, G. Jinghaui, C. Wenchao, J. X. Xiudi, W. Z. Xiudi and J. Xiudi (hereinafter “WANG et. al.”) in their 2011 article entitled “Adaptive Optimal-Kernel Time-Frequency Representation and its Application in Characterizing Seismic Attenuation,” published in the SEG Extended Abstract and incorporated herein by reference. It should be noted that the spectrogram, as described by D. Gabor in his 1946 article entitled “Theory of Communication,” published in the Journal of the Institute of Electrical Engineers, Vol. 93, pages 429-457 and incorporated herein by reference, is still commonly used to generate time-frequency representations.

However, when using such data processing techniques, the unavoidable tradeoff between temporal and spectral resolution, i.e., the so-called uncertainty principle, remained as a problem to overcome. To address this uncertainty principle shortcoming, other non-stationary representations have been proposed. Another representation, for example, is the wavelet transform and matching pursuit (MP) as described by S. Mallat and Z. Zhang in their 1993 article entitled “Matching Pursuits with Time-Frequency Dictionaries,” published in IEEE Transactions: Signal Processing, Vol. 41, No. 12, pages 3397-3415 and incorporated herein by reference. Although these techniques have been widely used in seismic signal analysis, the matching pursuit technique suffers from high computational complexity and its associated time-frequency resolution depends on careful selection of a dictionary of time-limited functions (also called atoms), which are used in linear combination to generate an expansion of the signal being processed.

Alternative representations include Cohen's class of bilinear time-frequency energy distributions as described by H. I. Choi and W. J. Williams in their 1989 article entitled Improved Time Frequency Representation of Multicomponent Signals using Exponential Kernels,” (hereinafter “CHOI et. al.”) published in IEEE Transactions: Acoustics, Speech, Signal Processing, Vol. 37, No. 6, pages 862-871, incorporated herein by reference. A prominent member of this class is the discrete Wigner-Ville distribution (DWV), which satisfies an exceptionally large number of desirable mathematical properties while exhibiting the least amount of spread in the time-frequency plane.

However, based on its quadratic nature, the Wigner-Ville distribution possesses a cross component, i.e., an interference term, for each pair of signal components as described by B. L. F. Aysin, I. G. Chaparro and V. Shusterman in their 2005 article entitled “Orthonormal-Basis Partitioning and Time-Frequency Representation of Cardiac Rhythm Dynamics,” published in IEEE Transactions: Biomedical Engineering, Vol. 52, pages 878-889 and incorporated herein by reference. The interference term leads to a reduction in the readability of the resulting representation when multicomponent or nonlinear frequency modulated signals are analyzed using this technique.

Efforts to reduce the impact of the cross-terms include the introduction of a fixed smooth kernel in the Wigner-Ville distribution. Examples of this technique include the smoothed Pseudo-Wigner-Ville distribution (SPWVD) as described by H. Franz, T. G. Manickam, R. L. Urbanke and W. Jones in their 1995 article entitled “Smoothed Pseudo-Wigner Distribution, Choi-Williams Distribution, and Cone-Kernel Representation: Ambiguity Domain Analysis and Experimental Comparison,” published in Elsevier Signal Processing, Vol. 43, pages 149-168, incorporated herein by reference and the Choi-Williams Distribution (CWD) by CHOI et. al.

Other attempts to reduce the impact of the cross-terms implement an adaptive kernel, such as that described by P. Steeghs and G. Drijkoningen in their 2001 article entitled “Seismic Sequence Analysis and Attribute Extraction Using Quadratic Time-Frequency Representations,” published in Geophysics, Vol. 66, pages 1947-1959 and incorporated herein by reference. The adaptive kernel approach has been used to characterize seismic attenuation as described by WANG et. al., however, attenuation of the cross-terms by smoothing generally results in an increase of time-frequency spread of the signal components and a reduction in the accuracy of the representation.

Accordingly, it would be desirable to provide systems and methods that avoid the afore-described problems and drawbacks, by reducing the impacts of cross-term interference and improving the accuracy of time-frequency representations which are generated using DWV techniques.

### SUMMARY

These, and other, issues are addressed by the embodiments described herein which, among other things reduce the impact of cross-term interference and improve the accuracy of time frequency representations, e.g., images, which are generated using Wigner-Ville distribution.

According to an embodiment, a method for performing a time-frequency analysis of seismic data includes the step of applying a maximum entropy method to computing a Wigner-Ville distribution of seismic traces for generating a time-frequency image of the seismic data.

According to another embodiment, a method, stored in a memory and executing on a processor, for reducing cross-term interference associated with a time-frequency analysis of seismic data includes the steps of computing a complex trace based on an analytic signal associated with a discrete Wigner-Ville distribution of the seismic data, computing a discrete Wigner-Ville distribution kernel based on a predetermined spectral resolution, computing a reflection coefficient based on equating coefficients of an autocorrelation function to an associated prediction error operator, computing an extended discrete Wigner-Ville distribution kernel based on the reflection coefficient; and computing an instantaneous power spectrum based on a discrete Fourier transform of said extended discrete Wigner-Ville distribution kernel.

According to another embodiment, a system for reducing cross-term interference associated with a time-frequency analysis of seismic data includes: a seismic dataset, one or more processors configured to execute computer instructions and a memory configured to store the computer instructions wherein the computer instructions further comprise a complex trace component for computing complex traces associated with analytic signals of a discrete Wigner-Ville distribution, a kernel component for computing Wigner-Ville kernels and Wigner-Ville extended kernels, a coefficient component for computing a reflection coefficient; and a power spectrum component for computing a power spectrum of the Wigner-Ville extended kernels.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1(a) depicts various aspects of an exemplary marine seismic survey system in which described embodiments can be implemented;

FIG. 1(b) is a flowchart illustrating a method according to an embodiment;

FIG. 2 depicts a comparison of the results of the described embodiments with other methods;

FIG. 3 depicts the effect of the choice of window length on the results of the described embodiments;

FIG. 4 depicts a seismic image of real data;

FIG. 5 depicts a seismic image of the instantaneous frequency of the real data of FIG. 4;

FIG. 6 depicts a spectral decomposition (5 Hz) of the seismic image of FIG. 5;

FIG. 7 depicts a frequency blending using 5 Hz, 15 Hz and 30 Hz associated with the seismic image of FIG. 6;

FIG. 8 is a method flowchart for associated with embodiments described herein;

FIG. 9 is a method flowchart associated with embodiments described herein;

FIG. 10 is a diagram of software components for implementing embodiments described herein; and

FIG. 11 illustrates an exemplary data processing device or system which can be used to implement the embodiments.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of high-resolution time-frequency representation of seismic traces based on a combination Wigner-Ville distribution and a maximum entropy method. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

The presented embodiments describe, for example, methods and systems for reducing cross-term interference associated with a time-frequency analysis of seismic data which is processed using the afore-described Discrete Wigner-Ville (DWV) distribution. The aforementioned interference reductions are based on the application of a maximum entropy method to the DWV distribution, wherein the power of each kernel of the DWV distribution is maximized.

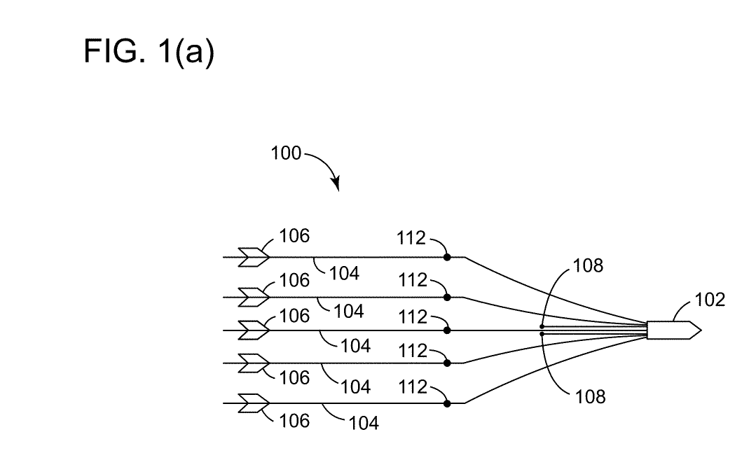

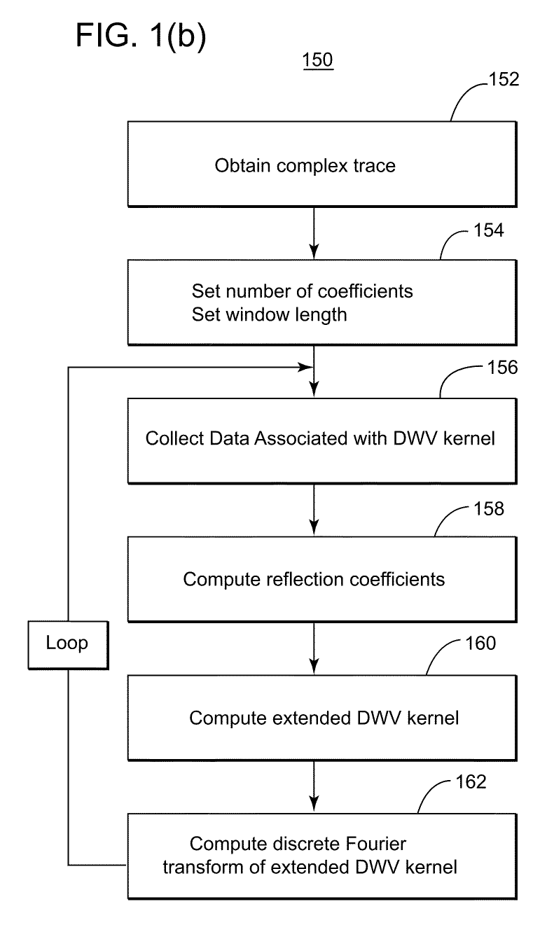

In order to provide some context for the subsequent exemplary embodiments related to configuring seismic acquisition systems, consider first a seismic data acquisition process and system. Looking to FIG. 1(a), a data acquisition system 100 includes a ship 102 towing a plurality of streamers 104 that can extend one or more kilometers behind the ship 102. Each of the streamers 104 can include one or more “birds” 106 that maintain the streamer 104 in a known fixed position relative to other streamers 104. Further, the one or more “birds” 106 are capable of moving the streamers 104 as desired according to bi-directional communications received by the birds 106 from the ship 102.

One or more source arrays 108 can also be towed by ship 102, or another ship (not shown), for generating seismic waves. Source arrays 108 can be placed either in front of or behind the receivers 112 (one representative receiver per streamer), or both behind and in front of the receivers 112. The seismic waves generated by the source arrays 108 propagate downward, reflect off of, and penetrate the seafloor, wherein the refracted waves eventually are reflected by one or more reflecting structures (not shown in FIG. 1) back to the surface of the sea. The reflected seismic waves then propagate upward and are detected by the receivers 112 disposed on the streamers 104. The seismic waves then reflect off of the free surface, i.e., the surface of the sea, traveling downward and are once again detected by the receivers 112 disposed on streamers 104 as receiver ghosts. This process is generally referred to as “shooting” a particular seafloor area, with the seafloor area referred to as a “cell” and the sea surface referred to as a “free surface.”

Note that although the foregoing context is provided in terms of a marine seismic acquisition system, that the embodiments to be described below are not limited thereto and may be applied to seismic data acquired in any desired manner using any desired system, e.g., marine, land, narrow azimuth, wide azimuth, etc.

With this general context regarding seismic acquisition in mind, some discussion of the discrete Wigner-Ville distribution (DWV) itself will also be useful to understand the subsequent embodiments. DWV is defined by BOASHASH as:

$$W ( t , f ) = {\int }_{- ∞}^{∞} x ( t + \frac{τ}{2} ) {x}^{*} ( t - \frac{τ}{2} ) {e}^{- 2 j π f τ} d τ \qquad ( 1 )$$

where x(t) is the signal, t is the time, f is the frequency and τ is the lag. Based on the quadratic nature of the distribution, the application of the Wigner-Ville distribution to seismic data is limited by the existence of interference terms. The interference terms can be described by considering elementary mono-components z(t) and g(t) wherein the Wigner-Ville distribution is then given by:

W_{z+g}=W_{z}(t,f)+W_{g}(t,f)+2Re[W_{z,g}(t,f)] (2)

where W_{z}(t, f) and W_{g}(t, f) are the auto-terms and Re[W_{z,g}(t, f)] represents the cross-terms observed between z(t) and g(t) which can lead to an erroneous visual interpretation of the time-frequency representation.

For the discrete Wigner-Ville distribution, the analytic signal z(n) which corresponds to a signal x(n) is defined in the time domain as:

z(n)=x(n)+jH[x(n)] (3)

where H[x(n)] represents the Hilbert transform of the signal x(n), n=0, . . . , Nₛ−1 and Nₛ is the number of samples. The analytical signal can be used to generate a covariance matrix as:

C_{z}=zz^{H} (4)

where the superscript H represents the transpose conjugate of the vector z. The hermitian property can be verified by the relationships Real{C_{z}}=Real{C_{z}^{T}} and Imag{C_{z}}=−Imag{C_{z}^{T}}.

An inspection of the covariance matrix shows that the sequence of terms along each cross-diagonal of C, is the kernel of the discrete Wigner-Ville distribution and can be written as:

K(n)={kₙ(−l), . . . ,kₙ(0), . . . ,kₙ(l)} (5)

with terms given as:

Kₙ(l)={z(n−l)z*(n+l),|l|≦min{n,Nₛ−n},0,|l|>min{n,Nₛ−n}}. (6)

It should be noted that the central term, kₙ(0)=z(n)z*(n), is associated with sample z(n) of the input signal.

Continuing the analysis, the Fourier transform (FT) of the kernel K(n) corresponds to the Wigner-Ville spectrum, which is the instantaneous power spectrum corresponding to the data point z(n), and can be expressed as:

$$W ( n ) = \{ {w}_{n} ( - \frac{N - 1}{2} ) , … , {w}_{n} ( 0 ) , … , {w}_{n} ( \frac{N - 1}{2} ) \} \qquad ( 7 )$$

with coefficients given by:

$${w}_{n} ( m ) = \frac{1}{N} {\sum }_{l = - ( N - 1 ) / 2}^{( N - 1 ) / 2} {k}_{n} ( l ) {W}_{4}^{m l} \qquad ( 8 )$$

where N is the number of terms used in the discrete Fourier transform (DFT). As described by B. Boashash in his 1987 article entitled “An Efficient Real-Time Implementation of the Wigner-Ville Distribution,” published in IEEE Transactions: Acoustics, Speech and Signal Processing, Vol. 35, pages 1611-1618 and incorporated herein by reference, equation (8) matches the standard form of a discrete Fourier transform with the exception of a “twiddle” factor, which is defined as the W₂=e^{-j2π/N}. It should be noted that the additional power of “2” represents a scaling of the frequency axis by a factor of two and that equation (8) can be evaluated efficiently using standard fast Fourier transform algorithms. The collection of instantaneous power spectrums provided by W(n), n=0, . . . , N_{S}−1, form the discrete Wigner-Ville distribution time-frequency representation of the signal. For the interested reader, a further discussion of the properties of the discrete Wigner-Ville distribution is available in the above-incorporated by reference article BOASHASH.

The other aspect of the soon to be described embodiments is the usage of the so-called maximum entropy method to the DWV. The maximum entropy method (MEM) is described by J. P. Burg (hereinafter “BURG”) in his 1975 Ph.D. dissertation entitled “Maximum Entropy Spectrum Analysis,” published by the Department of Geophysics at Stanford University, CA, USA and incorporated herein by reference, to compute the power spectrum for every sequence of K(n), n=0, . . . , . . . , Nₛ−1. The computations performed by BURG maximize the entropy of the power spectrum P(f) under the constraint that the first coefficients of the autocorrelation function (ACF) of the signal should be with previously known coefficients, r_{z}(τ), τ=0, 1, . . . , N_{c}.

The basic equation of the maximum entropy method proposed in BURG is given as:

$$P ( f ) = \frac{{E}_{{N}_{c}} Δ t}{{\vert 1 + {\sum }_{n = 1}^{{N}_{c}} {c}_{n} {e}^{- j 2 π fn Δ t} \vert}^{2}} \qquad ( 9 )$$

where cₙ, n=0, . . . , N_{c}, (c₀=1), is the prediction error operator (PEO) of order N_{c}, E_{N}_{_{c}} is its corresponding prediction error energy and f is limited by the Nyquist interval −1/(2Δt)≦f≦1/(2Δt).

Further, BURG derived the relationship between the coefficients of the autocorrelation function and the prediction error operator, which is obtained by solving the hermitian Toeplitz system of equations given as:

$$[ \begin{matrix}{r}_{z} ( 0 ) & {r}_{z} ( - 1 ) & … & {r}_{z} ( - {N}_{c} ) \\ {r}_{z} ( 1 ) & {r}_{z} ( 0 ) & ⋱ & ⋮ \\ ⋮ & ⋱ & {r}_{z} ( 0 ) & {r}_{z} ( - 1 ) \\ {r}_{z} ( {N}_{c} ) & … & {r}_{z} ( 1 ) & {r}_{z} ( 0 )\end{matrix} ] [ \begin{matrix}1 \\ c ( {N}_{c} , 1 ) \\ ⋮ \\ c ( {N}_{c} , {N}_{c} )\end{matrix} ] = [ \begin{matrix}{E}_{{N}_{c}} \\ 0 \\ ⋮ \\ 0\end{matrix} ] \qquad ( 10 )$$

Equation (10) can be solved using the algorithm described by N. Levinson (hereinafter “LEVINSON”) in his 1947 article entitled “The Weiner RMS (Root Mean Square) criterion in Filter Design and Prediction,” published in the Journal of Mathematics and Physics, Vol. 25, pages 261-278 and incorporated herein by reference, such that an expression can be written which relates the prediction error operator of order j−1(cⱼ₋₁), with the coefficients of the autocorrelation function, given as:

$${c}_{( i , j )} = \frac{{r}_{z} ( j ) + {\sum }_{i = 1}^{j - 1} {r}_{z} ( j - 1 ) c ( j - 1 , i )}{{E}_{j - 1}} \qquad ( 11 )$$

where c_{(i,j)} is the reflection coefficient. Application of equation (11) to the recursion of LEVINSON allows the determination of the prediction error operator of order j from the prediction error operator of order j−1, giving:

c_{(j,i)}=c_{(j-1,i)}+c_{(j,j)}c_{(j-1,j-1)}*,i=1, . . . ,j−1 (12)

and the corresponding prediction error energy, Eⱼ, can be updated giving:

Eⱼ=Eⱼ₋₁(1−c(j,j)c*(j,j)). (13)

It should be noted that equations (11), (12) and (13) are essentially the kernel of the LEVINSON algorithm, used to compute the prediction error operator from the coefficients of the autocorrelation function of a given signal wherein the recursion starts with E₀=r_{z}(0).

With this in mind, embodiments are now described which apply a maximum entropy method to the DWV to reduce the cross-term interference which occurs when conventional DWV is applied to generate time-frequency representations of seismic data.

More specifically, the terms of the Wigner-Ville kernels are computed and extended along the cross-diagonal of C_{z} using the BURG algorithm to provide the reflection coefficients c_{(i,j)} and the LEVINSON recursion in reverse order as described by M. J. Porsani and T. J. Ulrych in their 1989 article entitled “Discrete Convolution by Means of Forward and Backward Modeling,” published in IEEE Transactions: Acoustic, Speech and Signal Processing, Vol. 37, pages 1680-1687 and incorporated herein by reference. To do this, equation (11) can be rewritten as:

$${\tilde{k}}_{n} ( j ) = - {\sum }_{i = 1}^{j - 1} {\tilde{k}}_{n} ( j - 1 ) c ( j - 1 , i ) - c ( j , j ) {E}_{j - 1} . \qquad ( 14 )$$

Further, from the hermitian property of matrix C_{z}, it is known that \tilde{k}ₙ(−j)=\tilde{k}ₙ*(j). The maximum-entropy instantaneous power spectrum, corresponding to the kernel K(n), can now be obtained by computing the discrete Fourier transform of the expanded kernel \tilde{K}(n).

It is known by those skilled in the art that the BURG algorithm allows the computation of the reflection coefficients directly from the input trace which leads to, for a particular kernel K(n), a corresponding trace \tilde{z}(n) given by a window L expressed as:

$$\tilde{z} ( n ) = \{ z ( n = \frac{L}{2} ) , … , z ( n ) , … , z ( n + \frac{L}{2} ) \} \qquad ( 15 )$$

where L is the length of the symmetric time window centered at z(n). It should be noted that L is a parameter that, in conjunction with the number of coefficients N_{c} of the prediction error operator, controls the spectral resolution. In this regard, the BURG algorithm, equation (15), is particularly useful because it does not impose zeros outside the window, it does not require previous coefficients of the autocorrelation function and it provides a minimum phase prediction error operator as described by T. J. Ulrych and T. N. Bishop in their 1975 article entitled “Maximum Entropy Spectral Analysis and Autoregressive Decomposition,” published in Reviews of Geophysics, Vol. 13, pages 183-200 and incorporated herein by reference, T. J. Ulrych and R. W. Clayton in their 1976 article entitled “Time Series Modeling and Maximum Entropy,” published in Physics of the Earth and Planetary Interiors, Vol. 12, pages 188-200 and incorporated herein by reference, S. L. Marple in his 1978 article entitled “Frequency Resolution of High Resolution Spectrum Analysis Technique,” published in Proc. 1st RADC Spectrum Estimation Workshop, pages 19-35 and incorporated herein by reference, I. Barrodale and R. E. Erickson in their 1980 article entitled “Algorithm for Least-Squares Linear Prediction and Maximum Entropy Spectral Analysis—Part I: Theory,” published in Geophysics, Vol. 45, pages 420-432 and incorporated herein by reference and M. J. Porsani in his 1986 Ph.D dissertation entitled “Developing Levinson-Type Algorithms for Processing Seismic Data,” published at the Federal University of Bahia, Salvador, Brazil, www.pggeofisica.ufba.br/publicacoes/detalhe/205.

Based on the foregoing, a method for performing a time-frequency analysis of seismic data according to an embodiment can be described as illustrated in the flowchart of FIG. 1(b). Therein, a complex trace is obtained at step 152, e.g., based on the analytic signal of the discrete Wigner-Ville distribution of the acquired seismic data. Some initial algorithm variables are then set at step 154, i.e., the number of coefficients for the prediction error operator (PEO), and the length of the window over which to compute the PEO. The number of coefficients for the PEO can, for example, be set using the criteria of minimum error where the optimal number is estimated. Alternatively, this number can be randomly selected, e.g., suppose that the user wants to split the spectrum into five frequencies, then this number of coefficients will be set to five. However, according to one embodiment for seismic signal analysis, the number of coefficients for the PEO can be set to two, meaning that the energy of the spectrum will be concentrated around the instantaneous average frequency.

Then, a processing loop begins at step 156. Therein, data associated with the DWV kernel is collected, e.g., using equation (15) shown above. More specifically, equation (15) shows the collection of data in a window defined by L. Then, the reflection coefficients are computed at step 158, e.g., using equation (11) above. Next, the reflection coefficients are used to compute the extended DWV kernel, e.g., using equations (14), (12) and (13) above, at step 160. Then, the instantaneous power spectrum of the extended DWV kernel can be calculated at step 162, e.g., using equation (7) above.

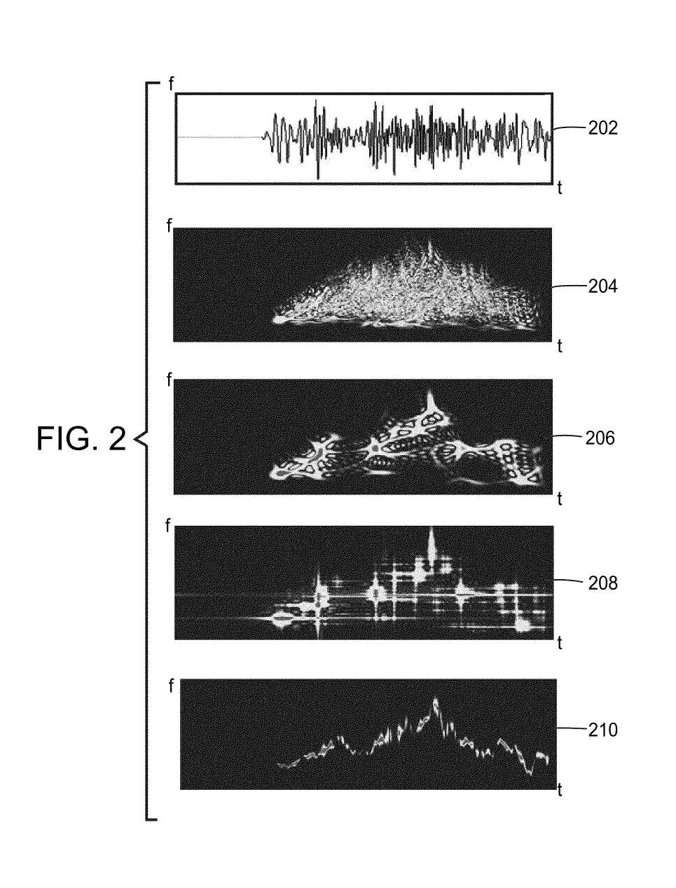

Some of the benefits of processing in accordance with embodiments, such as that described above with respect to FIG. 1(b), can be discerned by evaluating their outputs. For example, and now looking to FIG. 2, a comparison of images or representations which are generated by various techniques is provided. At the top of the Figure an original signal is shown as a function of frequency (f, y-axis) and time (t, x-axis). Then, outputs associated with processing the original signal 202 using the conventional Wigner-Ville distribution 204, the smoothed pseudo-Wigner-Ville distribution 206, the Choi-Williams distribution 208 and the above-described embodiments 210 are shown. As will be appreciated by those skilled in the art, the outputs 210 associated with the above-described embodiments depict improved energy resolution in both the time and frequency domain relative to the outputs 204, 206 and 208 produced by the other techniques.

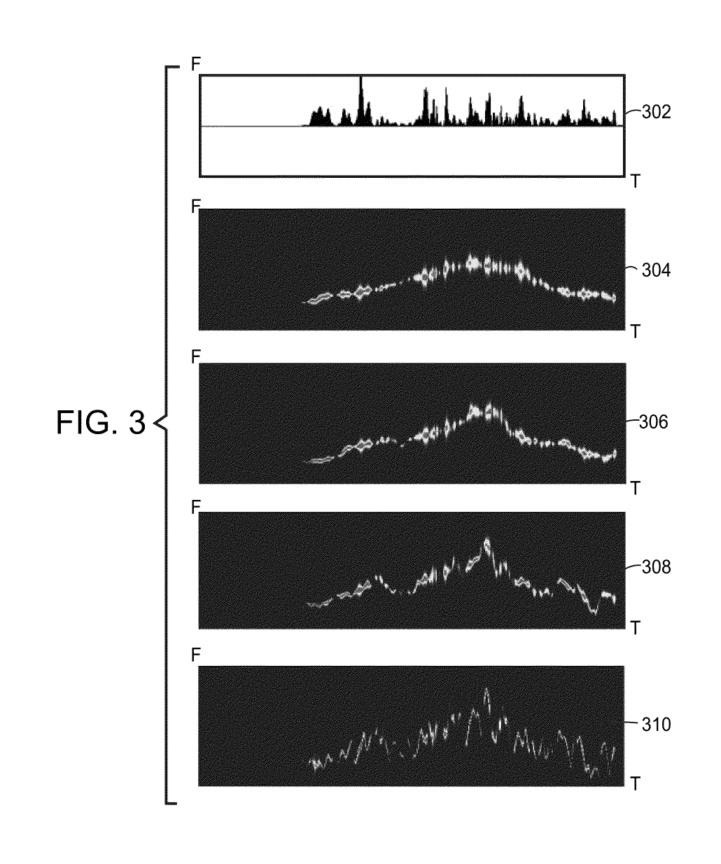

FIG. 3 presents the effect of choice of window length (L) in step 154 on the seismic image with window lengths of L=100 window 304, L=45 window 306, L=15 window 308 and L=5 window 310, based on the seismic data 202 used in the previous example. The envelope of the signal 302 is also depicted for comparison. From these images, it can be seen that as the window decreases, the time-frequency resolution of the resulting image increases. Additionally, it will be appreciated by those skilled in the art that the choice of window length L according to these embodiments provides for other benefits. For example, if smaller image details are needed for a particular seismic data interpretation, then a smaller window L may be used. Alternatively, if a smoothed seismic image is desired, then a larger window L may be used without compromising the image's resolution.

Consider now a real data application to which the above-described embodiments have been applied, i.e., a problem of identification of two areas associated with seismic data from the Gulf of Mexico. The embodiments described herein were applied to the analysis of the attenuation of acquired seismic data via the method of instantaneous frequency (IF) analysis. Further, an energy density distribution is obtained from the spectral decomposition of the seismic data. It shall be shown below that this analysis leads to an identification of an area of hydrates and an area of gas pocket.

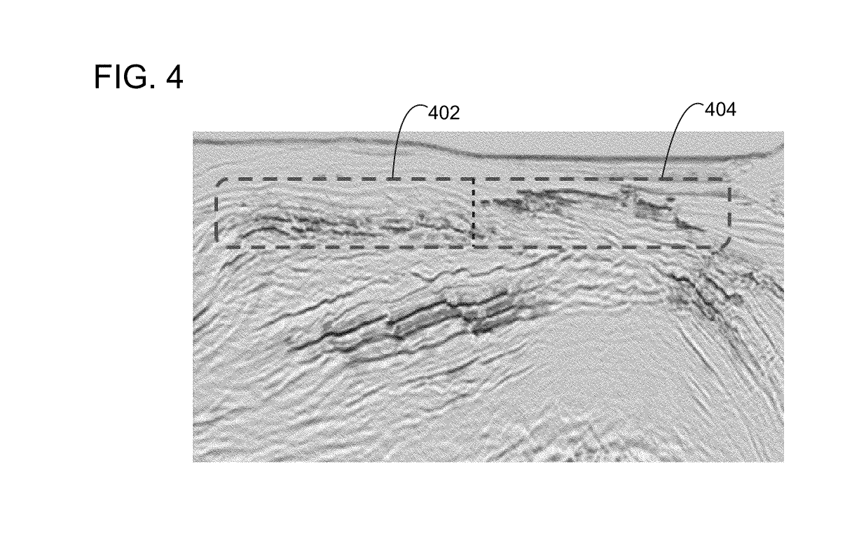

Looking to FIG. 4, depicted is a section of the Gulf of Mexico seismic data wherein areas 402, 404 of high energy reflectors can be observed in the shallows. Initially, it is not possible to associate both areas 402, 404 to the same event, e.g., the presence of gas or hydrates, or to a strong lithology contrast. Further, amplitude dimming in the structures at depth can be observed. Identifying the areas 402, 404 were based on attenuation characterization and energy density distribution. It should be noted that the attenuation effect can be understood by computing the first moments of the Wigner-Ville distribution, which corresponds to the instantaneous frequency of the signal as described by B. Boashash and H. J. Whitehouse in their 1986 article entitled “Seismic Applications of the Wigner-Ville Distribution,” published in IEEE, pages 34-37 and incorporated herein by reference. Further it should be noted that the energy density is obtained by a spectral decomposition. The average instantaneous frequency is given by:

$$I F ( t ) = \frac{{\int }_{- ∞}^{∞} fW ( t , f )}{{\int }_{- ∞}^{∞} W ( t , f ) } d t \qquad ( 16 )$$

where f is frequency and W(t, f) is the Wigner-Ville distribution.

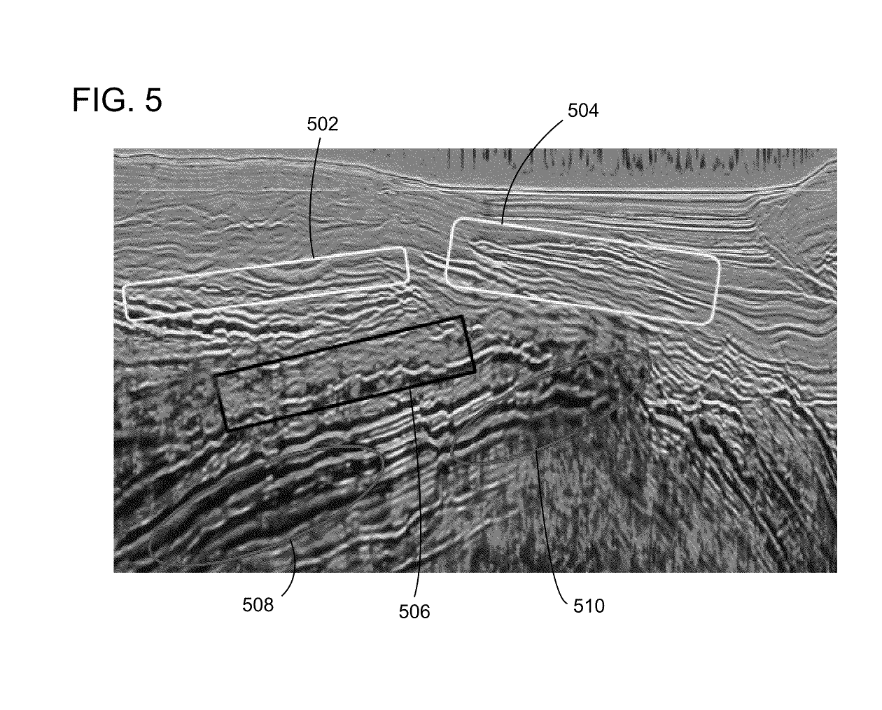

Looking to FIG. 5, depicted is the instantaneous frequency image of the seismic data of FIG. 4, which serves as measure of the attenuation effect. Three zones are defined, a high frequency zone (HFZ) 502, 504 of approximately 30 Hz, a median frequency zone (MFZ) 506 of approximately 15 Hz and a low frequency zone (LFZ) 508, 510 of approximately 5 Hz. It should be noted that the median frequency zone 506 is located below high frequency zone 502 and a low frequency zone 510 is located below the other high frequency zone 504. Although both high frequency zones 502, 504 cause attenuation, the attenuation effect of high frequency zone 502 is less than the attenuation effect of high frequency zone 504. It should further be noted that the attenuation effect on the low frequency zone 508 below high frequency zone 502 cannot be directly related to the high frequency zone 502. Accordingly, a spectral decomposition is performed to complete the analysis.

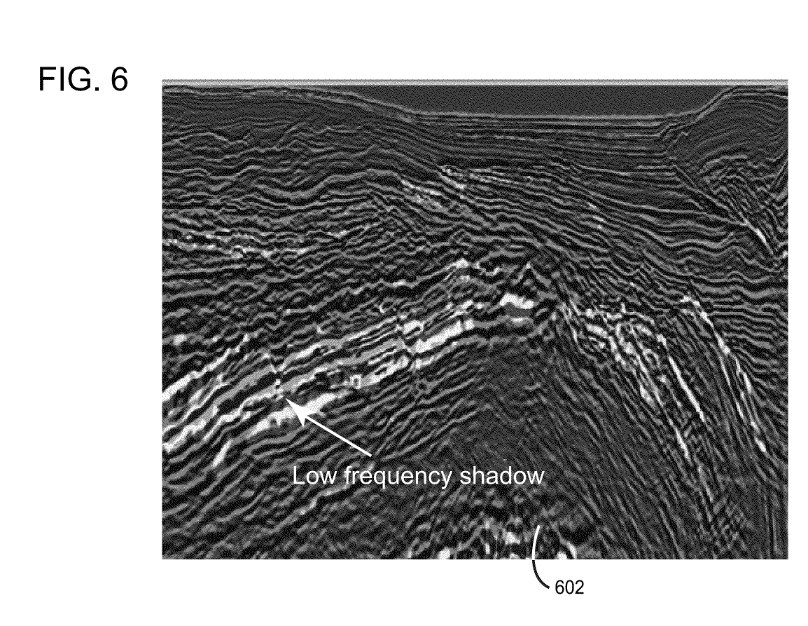

Next, looking to FIG. 6, a spectral decomposition at 5 Hz is depicted and a low frequency shadow 602 is observable which is commonly a direct hydrocarbon indicator as described by J. Castagna, S. Sun and R. Siegfried in their 2003 article entitled “Instantaneous Spectral Analysis: Detection of Low Frequency Shadows Associated with Hydrocarbons,” published in The Leading Edge, Vol. 22, pages 124-127 and incorporated herein by reference, Y. Wang in his 2007 article entitled “Seismic Time-Frequency Spectral Decomposition by Matching Pursuit,” published in Geophysics, Vol. 72 and incorporated herein by reference and O. Oliveira, O. Vilhena and E. Costa in their 2010 article entitled “Time-Frequency Spectral Signature of Pelotas Basin Deep Water Gas Hydrates System,” published in Marine Geophysical Research, Vol. 31, pages 89-97 and incorporated herein by reference.

The low frequency shadow 602 is generally caused by attenuation but can also be related to velocity effect or thin bed effect as described by T. Shenghong, J. C. Puryear and P. Castagna in their 2009 article entitled “Local Frequency as a Direct Hydrocarbon Indicator,” published in SEG Extended Abstract and incorporated herein by reference and Y. Wang in his 2010 article entitled “Reservoir Characterization Based on Spectral Variations,” published in Geophysics, Vol. 77, pages 89-95 and incorporated herein by reference. Interpreting the low frequency shadow 602 as an indicator of a hydrocarbon, the amplitude dimming of the low frequency zone 508 is presumed to be caused by a reservoir and not related to the high frequency zone 502.

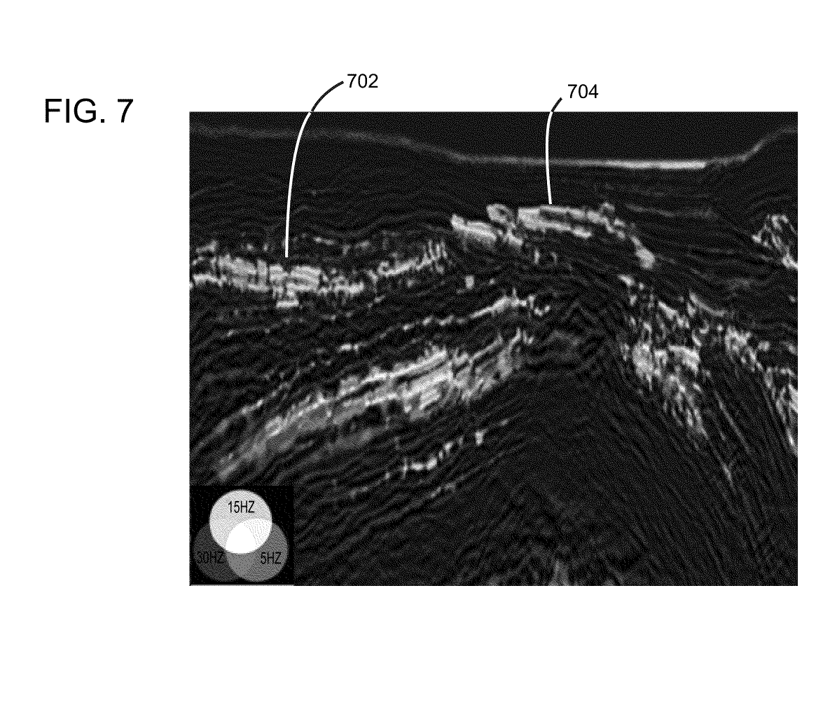

Considering a frequency blending image of this data, depicted in FIG. 7 and which is applied following the spectral decomposition in FIG. 6, where the sharpness and extent of both high frequency zones 702, 704 can clearly be observed, both zones 702, 704 display high energy density, but each zone is associated with a different dominant frequency. One zone 702 is blended with a greater amount of low frequency energy (approximately 15 Hz) whereas the other zone 704 is blended with a greater amount of high frequency energy (approximately 30 Hz). Based on these observations, the conclusion is reached that the images for these two zones 702, 704 are not based on the same event. It is predicted, and was subsequently shown, that one zone 702 indicated the presence of hydrates and the other zone 704 indicated the presence of a gas pocket.

Among other things, those skilled in the art will appreciate from a review of FIGS. 4-7 that the processing of data in accordance with the foregoing embodiments provides the ability to map the seismic image shapes with high accuracy in both time and frequency based on the usage of the maximum entropy method as described above to provide such resolution to the images. Accordingly, this enables those skilled in the art, who are analyzing the seismic images generated using these embodiments to have a higher degree of trust in the images' illustrations of energy distributions.

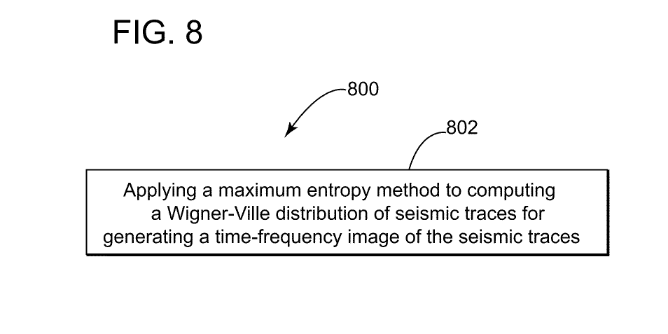

Although FIG. 1(b) expresses one method embodiment, it will be appreciated that methods for performing time-frequency analysis of seismic data can be expressed in other ways. Looking now to FIG. 8, a more general method embodiment 800 for performing a time-frequency analysis of seismic data is depicted. At step 802, the method embodiment 800 applies a maximum entropy method to a Wigner-Ville distribution of seismic traces for generating a time-frequency image of the seismic traces.

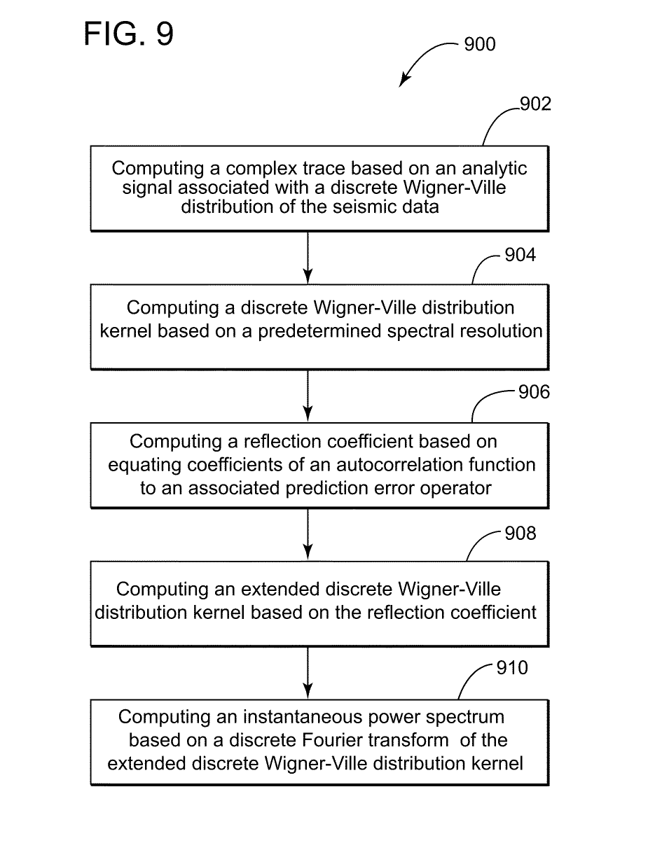

Looking now to FIG. 9, another method embodiment 900 for reducing cross-term interference associated with a time-frequency analysis of seismic data is depicted. Starting at step 902, the method embodiment 900 computes a complex trace based on an analytic signal associated with a discrete Wigner-Ville distribution of the seismic data. Next at step 904, the method embodiment 900 computes a discrete Wigner-Ville distribution kernel based on a predetermined spectral resolution. Continuing at step 906, the method embodiment 900 computes a reflection coefficient based on equating coefficients of an autocorrelation function to an associated prediction error operator. Further, at step 908, the method embodiment 900 computes an extended discrete Wigner-Ville distribution kernel based on the reflection coefficient. Next at step 910, the method embodiment 900 computes an instantaneous power spectrum based on a discrete Fourier transform of the extended discrete Wigner-Ville distribution kernel.

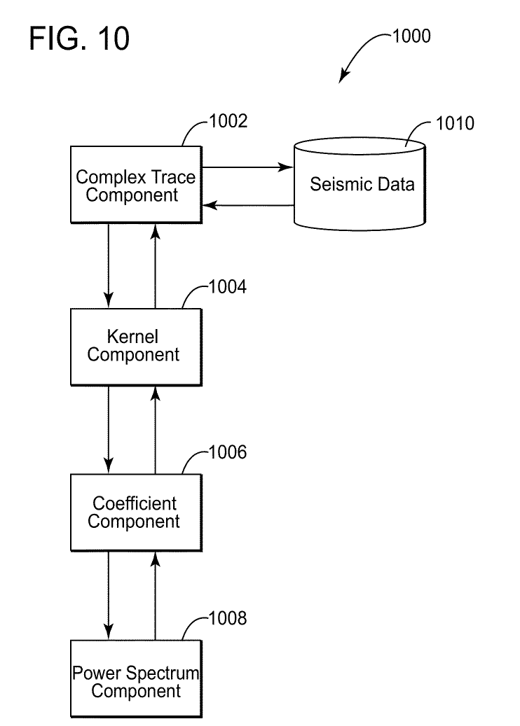

The afore-described algorithms and methods can also be implemented as systems. Looking to FIG. 10, a system embodiment 1000 for reducing cross-term interference associated with a time-frequency analysis of seismic data 1010 comprises a complex trace component 1002, a kernel component 1004, a coefficient component 1006, a power spectrum component 1008 and seismic data 1010.

First, the complex trace component 1002 provides the capability for computing complexes traces associated with analytic signals of a discrete Wigner-Ville distribution. It should be noted that the complex trace component can employ a Hilbert transform component to produce the complex traces. Next, the kernel component 1004 provides the capability for computing Wigner-Ville kernels and extended Wigner-Ville kernels. The coefficient component 1006 provides the capability to compute a reflection coefficient based on equating coefficients of an autocorrelation function to an associated prediction error operator. Next, the power spectrum component provides the capability to compute an instantaneous power spectrum based on a discrete Fourier transform of the extended discrete Wigner-Ville distribution kernel.

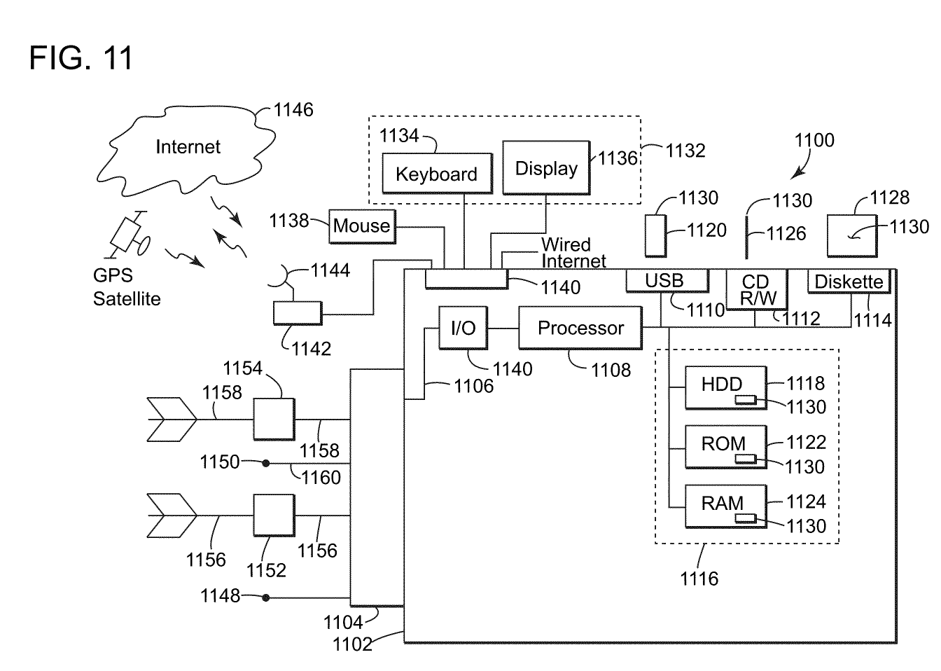

The computing device(s) or other network nodes involved in reducing cross-term interference associated with a time-frequency analysis of seismic data as set forth in the above described embodiments may be any type of computing device capable of processing and communicating seismic data associated with a seismic survey. An example of a representative computing system capable of carrying out operations in accordance with these embodiments is illustrated in FIG. 11. System 1100 includes, among other items, server 1102, source/receiver interface 1104, internal data/communications bus (bus) 1106, processor(s) 1108 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 1110, compact disk (CD)/digital video disk (DVD) read/write (R/W) drive 1112, floppy diskette drive 1114 (though less used currently, many servers still include this device), and data storage unit 1116.

Data storage unit 1116 itself can comprise hard disk drive (HDD) 1118 (these can include conventional magnetic storage media, but, as is becoming increasingly more prevalent, can include flash drive-type mass storage devices 1120, among other types), ROM device(s) 1122 (these can include electrically erasable (EE) programmable ROM (EEPROM) devices, ultra-violet erasable PROM devices (UVPROMs), among other types), and random access memory (RAM) devices 1124. Usable with USB port 1110 is flash drive device 1120, and usable with CD/DVD R/W device 1112 are CD/DVD disks 1126 (which can be both read and write-able). Usable with diskette drive device 1114 are floppy diskettes 1128. Each of the memory storage devices, or the memory storage media (1118, 1120, 1122, 1124, 1126, and 1128, among other types), can contain parts or components, or in its entirety, executable software programming code (software) 1130 that can implement part or all of the portions of the method described herein. Further, processor 1108 itself can contain one or different types of memory storage devices (most probably, but not in a limiting manner, RAM memory storage media 1124) that can store all or some of the components of software 1130.

In addition to the above described components, system 1100 also comprises user console 1132, which can include keyboard 1134, display 1136, and mouse 1138. All of these components are known to those of ordinary skill in the art, and this description includes all known and future variants of these types of devices. Display 1136 can be any type of known display or presentation screen, such as liquid crystal displays (LCDs), light emitting diode displays (LEDs), plasma displays, cathode ray tubes (CRTs), among others. User console 1132 can include one or more user interface mechanisms such as a mouse, keyboard, microphone, touch pad, touch screen, voice-recognition system, among other inter-active inter-communicative devices.

User console 1132, and its components if separately provided, interface with server 1102 via server input/output (I/O) interface 1140, which can be an RS232, Ethernet, USB or other type of communications port, or can include all or some of these, and further includes any other type of communications means, presently known or further developed. System 1100 can further include communications satellite/global navigation satellite system (GNSS)/global positioning system (GPS) transceiver device 1142, to which is electrically connected at least one antenna 1144 (according to an embodiment, there would be at least one GPS receive-only antenna, and at least one separate satellite bi-directional communications antenna). System 1100 can access internet 1146, either through a hard wired connection, via I/O interface 1140 directly or wirelessly via antenna 1144, and transceiver 1142.

Server 1102 can be coupled to other computing devices, such as those that operate or control the equipment of vessel 102 of FIG. 1, via one or more networks. Server 1102 may be part of a larger network configuration as in a global area network (GAN) (e.g., internet 1146), which ultimately allows connection to various landlines.

According to a further embodiment, system 1100, being designed for use in seismic exploration, will interface with one or more source arrays 1148, 1150 and one or more receivers 1152, 1154. As further previously discussed, sources 1148, 1150 and receivers 1152, 1154 can communicate with server 1102 either through an electrical cable that is part of streamer 1156, 1158, or via a wireless system that can communicate via antenna 1144 and transceiver 1142 (collectively described as communications conduit 1160).

According to further exemplary embodiments, user console 1132 provides a means for personnel to enter commands and configuration into system 1100 (e.g., via a keyboard, buttons, switches, touch screen and/or joy stick). Display device 1136 can be used to show: source/receiver 1156, 1158 position; visual representations of acquired data; source 1148, 1150 and receiver 1152, 1154 status information; survey information; and other information important to the seismic data acquisition process. Source and receiver interface unit 1104 can receive the seismic data from receiver 1152, 1154 though communication conduit 1160 (discussed above). Source and receiver interface unit 1104 can also communicate bi-directionally with sources 1148, 1150 through the communication conduit 1160. Excitation signals, control signals, output signals and status information related to source 1148, 1150 can be exchanged by communication conduit 1160 between system 1100 and source 1148, 1150.

Bus 1106 allows a data pathway for items such as: the transfer and storage of data that originate from either the source sensors or receivers through an I/O processor 1162; for processor 1108 to access stored data contained in data storage unit memory 1116; for processor 1108 to send information for visual display to display 1136; or for the user to send commands to system operating programs/software 1130 that might reside in either the processor 1108 or the source and receiver interface unit 1104.

System 1100 can be used to implement the methods described above associated with reducing cross-term interference associated with a time-frequency analysis of seismic data according to an exemplary embodiment. Hardware, firmware, software or a combination thereof may be used to perform the various steps and operations described herein. According to an exemplary embodiment, software 1130 for carrying out the above discussed steps can be stored and distributed on multi-media storage devices such as devices 1118, 1120, 1122, 1124, 1126, and/or 1128 (described above) or other form of media capable of portably storing information (e.g., universal serial bus (USB) flash drive 1120). These storage media may be inserted into, and read by, devices such as the CD-ROM drive 1112, the disk drive 1114, among other types of software storage devices.

The disclosed exemplary embodiments provide a server node, and a method for reducing cross-term interference associated with a time-frequency analysis of seismic data. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method, stored in a memory and executing on a processor, for performing a time-frequency analysis of seismic data, said method comprising:
applying a maximum entropy method to computing a Wigner-Ville distribution of seismic traces for generating a time-frequency image of said seismic data.

2. The method of claim 1, wherein said Wigner-Ville distribution is a discrete Wigner-Ville distribution.

3. The method of claim 2, wherein said computing said discrete Wigner-Ville distribution comprises:
computing a complex trace based on an analytic signal of a discrete Wigner-Ville distribution of said seismic data;
computing a discrete Wigner-Ville distribution kernel based on a predetermined spectral resolution;
computing a reflection coefficient; and
computing an extended discrete Wigner-Ville distribution kernel.

4. The method of claim 3, wherein said applying said maximum entropy method comprises:
computing an instantaneous power spectrum based on a discrete Fourier transform of said extended discrete Wigner-Ville distribution kernel.

5. The method of claim 4, wherein said instantaneous power spectrum is maximized for each kernel of said extended discrete Wigner-Ville distribution kernel.

6. The method of claim 3, wherein said spectral resolution is based on a predetermined number of coefficients for a prediction error operator and a predetermined length of a symmetric time window centered on said analytic signal.

7. The method of claim 3, wherein said reflection coefficient is based on a relationship between coefficients associated with an autocorrelation function and said prediction error operator.

8. The method of claim 3, wherein said computing an extended discrete Wigner-Ville distribution kernel is based on application of said reflection coefficient to said discrete Wigner-Ville kernel.

9. A method, stored in a memory and executing on a processor, for reducing cross-term interference associated with a time-frequency analysis of seismic data, said method comprising:
computing a complex trace based on an analytic signal associated with a discrete Wigner-Ville distribution of said seismic data;
computing a discrete Wigner-Ville distribution kernel based on a predetermined spectral resolution;
computing a reflection coefficient based on equating coefficients of an autocorrelation function to an associated prediction error operator;
computing an extended discrete Wigner-Ville distribution kernel based on said reflection coefficient; and
computing an instantaneous power spectrum based on a discrete Fourier transform of said extended discrete Wigner-Ville distribution kernel.

10. The method of claim 9, wherein said analytic signal is based on a Hilbert transform of an associated seismic signal.

11. The method of claim 10, wherein a covariance matrix is generated based on a plurality of said analytic signals.

12. The method of claim 11, wherein a sequence of terms along each cross-diagonal of said covariance matrix is a kernel of said discrete Wigner-Ville distribution.

13. The method of claim 9, wherein said spectral resolution is based on a predetermined number of coefficients for a prediction error operator and a predetermined length of a symmetric time window centered on said analytic signal.

14. The method of claim 13, wherein said reflection coefficient is based on a relationship between coefficients associated with an autocorrelation function and said prediction error operator.

15. The method of claim 9, wherein said computing an extended discrete Wigner-Ville distribution kernel is based on application of said reflection coefficient to said discrete Wigner-Ville kernel.

16. The method of claim 9, wherein said discrete Fourier transform comprises an additional power of 2 associated with scaling a frequency axis by a factor of two.

17. A system for reducing cross-term interference associated with a time-frequency analysis of seismic data, said system comprising:
a seismic dataset;
one or more processors configured to execute computer instructions and a memory configured to store said computer instructions wherein said computer instructions further comprise:
a complex trace component for computing complex traces associated with analytic signals of a discrete Wigner-Ville distribution;
a kernel component for computing Wigner-Ville kernels and Wigner-Ville extended kernels;
a coefficient component for computing a reflection coefficient; and
a power spectrum component for computing a power spectrum of said Wigner-Ville extended kernels.

18. The system of claim 17, wherein said complex trace component further comprises:
a Hilbert Transform for transforming a signal trace to said analytic signal.

19. The system of claim 17, wherein said power spectrum component further comprises:
a discrete Fourier transform for transforming an extended Wigner-Ville kernel to an instantaneous power spectrum.

20. The system of claim 17, wherein said coefficient component computes a reflection coefficient based on equating coefficients of an autocorrelation function to an associated prediction error operator.
